(19) United States
(12) Patent Application Publication
(10) Pub. No.: US 2026/0245158 A1
(43) Pub. Date: Aug. 20, 2026

(54) MACHINE LEARNING BASED SUBDIVISION BOUNDARY GENERATION

(71) Applicant: CoreLogic Solutions, LLC, Irvine, CA (US)

(72) Inventors: Kien Trong Trinh, San Diego, CA (US); Bin He, Philadelphia, PA (US)

(21) Appl. No.: 19/543,722

(22) Filed: Feb. 18, 2026

Related U.S. Application Data
(60) Provisional application No. 63/760,543, filed on Feb. 19, 2025.

(51) Int. Cl. G06Q 50/16

(52) U.S. Cl. CPC G06Q 50/165

(57) ABSTRACT

The present disclosure generally relates to systems and methods for generating subdivision boundaries based on extracted subdivision information from parcel data. In some embodiments, the subdivision boundary system can classify, extract, and standardize information from parcel data to generate “cleaned” parcel data. This cleaned parcel data can be used to generate subdivision boundaries that merge parcels that are likely to belong to the same subdivision within the same boundary. In some embodiments, the subdivision boundary system can complete and correct subdivision boundaries by refilling missing subdivision names. In some embodiments, a boundary system can access the subdivision information (e.g., subdivision names) stored in the subdivision data store and other information (e.g., map information, geographical information) to generate a boundary corresponding to a subdivision. Boundary system can edit, update, or otherwise adjust the geometries of existing boundaries or create new boundaries based on the extracted subdivision information.

### CROSS-REFERENCE TO RELATED APPLICATIONS

This present application claims priority from U.S. Provisional No. 63/760,543 filed on Feb. 19, 2025, entitled MACHINE LEARNING BASED SUBDIVISION BOUNDARY GENERATION, which is hereby incorporated by reference herein in its entirety. Any and all applications for which a foreign or domestic priority claim is identified in the Application Data Sheet as filed with the present application are hereby incorporated by reference under 37 CFR 1.57 for all purposes and for all that they contain.

### BACKGROUND

In the context of property, subdivision may refer to the process of dividing a piece of land into smaller lots or divisions. Subdivision can include the adjustment of any geographical boundaries such as the realignment of existing property lines or the consolidation of multiple lots into a single lot. Subdivisions can be labeled with a subdivision name which can reflect certain characteristics relating to the subdivision, such as a location, marketing strategies, persons, community, and the like.

### SUMMARY

The systems, methods, and devices of this disclosure each have several innovative aspects, no single one of which is solely responsible for all of the desirable attributes disclosed herein. Details of one or more implementations of the subject matter described in this specification are set forth in the accompanying drawings and descriptions below.

In some aspects, the techniques described herein relate to a system, comprising: a computer-readable storage medium storing program instructions; and one or more processors configured to execute the program instructions to cause the system to: access parcel data, wherein the parcel data comprises information relating to a parcel of land; provide parcel data as an input to a first machine learning model, wherein the first machine learning model outputs a determination that the parcel data is missing a subdivision name; provide parcel data as an input to a second machine learning model, wherein the second machine learning model outputs subdivision data extracted from the parcel data; provide the extracted subdivision data and the parcel data as an input to a third machine learning model, wherein the third machine learning model outputs a standardized subdivision data that identifies the subdivision name; generate a subdivision by merging the parcel of land with additional parcels of land associated with the subdivision name; and generate a geometric boundary for the subdivision based on the subdivision name and a subdivision attribute.

In some aspects, the techniques described herein relate to a system, wherein the parcel data includes at least one of a parcel ID, a parcel geometry, a street name, a street number, a zip code, a county identifier, a census block group identifier, a legal description, a land use code, a property indicator, a land area, a year of construction, or assessor parcel number.

In some aspects, the techniques described herein relate to a system, wherein the second machine learning model is configured to: extract a first portion of subdivision data related to the subdivision name of the parcel; extract a second portion of subdivision data related to a phase of the parcel; and extract a third portion of the subdivision data related to a section of the parcel.

In some aspects, the techniques described herein relate to a system, wherein the third machine learning model is configured to compare the subdivision name to subdivision names of neighboring parcels of land to identify the standardized subdivision data that identifies the subdivision name.

In some aspects, the techniques described herein relate to a system, wherein the program instructions, when executed, further cause the one or more processors to generate the subdivision by merging the parcel of land with additional parcels of land associated with the subdivision name over a threshold number of parcels.

In some aspects, the techniques described herein relate to a system, wherein the program instructions, when executed, further cause the one or more processors to generate a buffer associated with the geometric boundary, the buffer corresponding to at least one of a road, street, or right of way.

In some aspects, the techniques described herein relate to a system, wherein the program instructions, when executed, further cause the one or more processors to cause display of the geometric boundary of the subdivision.

In some aspects, the techniques described herein relate to a method, comprising: accessing parcel data, wherein the parcel data comprises information relating to a parcel of land; providing parcel data as an input to a first machine learning model, wherein the first machine learning model outputs a determination that the parcel data is missing a subdivision name; providing parcel data as an input to a second machine learning model, wherein the second machine learning model outputs subdivision data extracted from the parcel data; providing the extracted subdivision data and the parcel data as an input to a third machine learning model, wherein the third machine learning model outputs a standardized subdivision data that identifies the subdivision name; generating a subdivision by merging the parcel of land with additional parcels of land associated with the subdivision name; and generating a geometric boundary for the subdivision based on the subdivision name and a subdivision attribute.

In some aspects, the techniques described herein relate to a method, wherein the parcel data includes at least one of a parcel ID, a parcel geometry, a street name, a street number, a zip code, a county identifier, a census block group identifier, a legal description, a land use code, a property indicator, a land area, a year of construction, or assessor parcel number.

In some aspects, the techniques described herein relate to a method, wherein the second machine learning model is configured to: extract a first portion of subdivision data related to the subdivision name of the parcel; extract a second portion of subdivision data related to a phase of the parcel; and extract a third portion of the subdivision data related to a section of the parcel.

In some aspects, the techniques described herein relate to a method, wherein the third machine learning model is configured to compare the subdivision name to subdivision names of neighboring parcels of land to identify the standardized subdivision data that identifies the subdivision name.

In some aspects, the techniques described herein relate to a method, further comprising generating the subdivision by merging the parcel of land with additional parcels of land associated with the subdivision name over a threshold number of parcels.

In some aspects, the techniques described herein relate to a method, further comprising generating a buffer associated with the geometric boundary, the buffer corresponding to at least one of a road, street, or right of way.

In some aspects, the techniques described herein relate to a method, further comprising causing display of the geometric boundary of the subdivision.

In some aspects, the techniques described herein relate to one or more non-transitory computer-readable media storing computer-executable instructions that, when executed by a computing system comprising a processor, cause the computing system to: access parcel data, wherein the parcel data comprises information relating to a parcel of land; provide parcel data as an input to a first machine learning model, wherein the first machine learning model outputs a determination that the parcel data is missing a subdivision name; provide parcel data as an input to a second machine learning model, wherein the second machine learning model outputs subdivision data extracted from the parcel data; provide the extracted subdivision data and the parcel data as an input to a third machine learning model, wherein the third machine learning model outputs a standardized subdivision data that identifies the subdivision name; generate a subdivision by merging the parcel of land with additional parcels of land associated with the subdivision name; and generate a geometric boundary for the subdivision based on the subdivision name and a subdivision attribute.

In some aspects, the techniques described herein relate to one or more non-transitory computer-readable media storing computer-executable instructions, wherein the parcel data includes at least one of a parcel ID, a parcel geometry, a street name, a street number, a zip code, a county identifier, a census block group identifier, a legal description, a land use code, a property indicator, a land area, a year of construction, or assessor parcel number.

In some aspects, the techniques described herein relate to one or more non-transitory computer-readable media storing computer-executable instructions, wherein the second machine learning model is configured to: extract a first portion of subdivision data related to the subdivision name of the parcel; extract a second portion of subdivision data related to a phase of the parcel; and extract a third portion of the subdivision data related to a section of the parcel.

In some aspects, the techniques described herein relate to one or more non-transitory computer-readable media storing computer-executable instructions, wherein the third machine learning model is configured to compare the subdivision name to subdivision names of neighboring parcels of land to identify the standardized subdivision data that identifies the subdivision name.

In some aspects, the techniques described herein relate to one or more non-transitory computer-readable media storing computer-executable instructions, wherein the computer-executable instructions, when executed, further cause the computing system to: generate the subdivision by merging the parcel of land with additional parcels of land associated with the subdivision name over a threshold number of parcels.

In some aspects, the techniques described herein relate to one or more non-transitory computer-readable media storing computer-executable instructions, wherein the computer-executable instructions, when executed, further cause the computing system to generate a buffer associated with the geometric boundary, the buffer corresponding to at least one of a road, street, or right of way.

### BRIEF DESCRIPTION OF THE DRAWINGS

Various features will now be described with reference to the following drawings. Throughout the drawings, reference numbers may be re-used to indicate correspondence between referenced elements. The drawings are provided to illustrate examples described herein and are not intended to limit the scope of the disclosure.

FIG. 1 is a schematic block diagram depicting an example network environment in which a subdivision boundary system may operate to generate a subdivision boundary, according to various aspects of the present disclosure.

FIG. 2 is an example data flow process in which the subdivision boundary system may operate to generate a subdivision boundary, according to various aspects of the present disclosure.

FIG. 3 illustrates example input parcel data that is fed in a classifier model by the subdivision boundary system, according to various aspects of the present disclosure.

FIG. 4 illustrates example classified parcel data that is extracted by the subdivision boundary system, according to various aspects of the present disclosure.

FIGS. 5A and 5B illustrate example map interfaces illustrating subdivision boundaries generated by the subdivision boundary system, according to various aspects of the present disclosure.

FIG. 6 illustrates a block diagram illustrating components of an example computing system that can be used to implement the various systems and methods described herein.

FIG. 7 is a flow diagram illustrating an example routine for generating a subdivision boundary, according to various aspects of the present disclosure.

### DETAILED DESCRIPTION

Generally described, aspects of the present disclosure relate to efficient mechanisms for generating and delineating subdivision boundaries based on parcels within a geographical area.

Parcels of land (“parcels”) can include any specific area of land that is legally defined and recorded in public records. Parcels can be grouped together within larger subdivisions. Oftentimes, the boundaries of subdivisions (or parcel within subdivisions) can be delineated. However, due to difficulty in collecting geographical data (e.g., over a widespread area), collection of inaccurate data, or infrequent data updates, subdivision boundary delineation may not always be accurate. For example, land use types and subdivision names from survey data (or other sources) can be incomplete (e.g., missing information) and/or often contain inaccuracies. This can result in incomplete or inaccurate subdivision boundary delineations. In addition, missing subdivision names can result in undefined subdivision boundaries.

The embodiments disclosed herein improve the ability of computing systems, such as the subdivision boundary system disclosed herein, to generate subdivision boundaries for groups of parcels based on extracted subdivision information. The subdivision boundary system can access parcel data relating to parcels of land in a given geographical area. This process can result in more accurate generation and/or delineation of subdivision boundaries based on standardized parcel data. As noted above, parcel data is often inaccurate and/or missing information. The subdivision boundary system can classify, extract, and standardize information from parcel data to generate “cleaned” parcel data. This cleaned parcel data can be used by the subdivision boundary system to generate subdivision boundaries and/or to merge parcels that are likely to belong to the same subdivision within the same boundary. The subdivision boundary system can complete and correct subdivision boundaries by refilling missing subdivision names. This can allow the generation and display of accurate subdivisions within a geographical location.

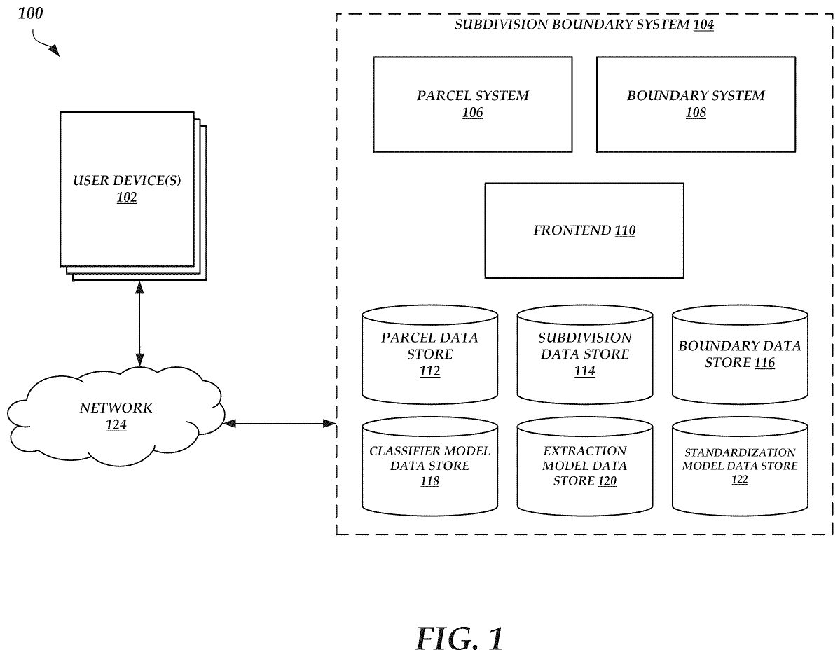

FIG. 1 is a schematic block diagram depicting an example network environment 100 in which a subdivision boundary system 104 may operate to generate a subdivision boundary, according to various aspects of the present disclosure.

As shown in FIG. 1, the network environment 100 includes user device(s) 102 (hereinafter referred to as “user device 102” for ease of reference), subdivision boundary system 104, and network 124. Subdivision boundary system 104 includes various components such as parcel system 106, boundary system 108, and frontend 110. In addition, the subdivision boundary system 104 includes various databases or data stores, such as parcel data store 112, subdivision data store 114, boundary data store 116, classifier model data store 118, extraction model data store 120, and standardization model data store 122. Classifier model data store 118, extraction model data store 120, and standardization model data store 122 can be collectively referred to as the “models.” The components of the subdivision boundary system 104 may be communicatively coupled via network 124. In addition, the network 124 may connect the user device 102 to the subdivision boundary system 104 and various components of the subdivision boundary system 104. Network environment 100 and components of the network environment 100 can include various hardware components and software components and can provide functionality as described further herein. In addition, components of the network environment 100 and the subdivision boundary system 104 can include more or less components than as shown in FIG. 1.

In various aspects, communications among the various components of the example network environment 100 and the subdivision boundary system 104 may be accomplished via any suitable device, systems, methods, and/or the like. For example, the subdivision boundary system 104 may communicate with the user device 102 and any remote data stores (not shown), via any combination of the network 124 or any other wired or wireless communication networks, methods (e.g., Bluetooth, WiFi, infrared, cellular, and/or the like). As further described below, the network 124 may comprise, for example, one or more internal or external networks, the Internet, and/or the like.

Network 124 of the network environment 100 can include any appropriate network, including wired network, wireless network, or combination thereof. For example, network 124 may be a personal area network, local area network, wide area network, cable network, satellite network, cellular network, or any other such network or combination thereof. As a further example, the network 124 may be a publicly accessible network of linked networks, possibly operated by various distinct parties, such as the Internet. Protocols and components for communicating via the Internet or any other types of communication networks are known to those skilled in the art of computer communications and thus, need not be described in more detail herein. In various embodiments, the network 124 may be a private or semi-private network, such as a corporate or university intranet. The network 124 may include one or more wireless networks, such as a Global System for Mobile Communications (GSM) network, a Code Division Multiple Access (CDMA) network, a Long-Term Evolution (LTE) network, C-band, mmWave, sub-6 GHz, or any other type of wireless network. The network 124 can use protocols and components for communicating via the Internet or any of the other aforementioned types of networks. For example, the protocols used by the network 124 may include Hypertext Transfer Protocol (HTTP), HTTP Secure (HTTPS), Message Queue Telemetry Transport (MQTT), Constrained Application Protocol (CoAP), and the like. Protocols and components for communicating via the Internet or any of the other aforementioned types of communication networks are well known to those skilled in the art of computer communications and thus, need not be described in more detail herein.

In various implementations, the network 124 can represent a network that may be local to a particular organization, e.g., a private or semi-private network, such as a corporate or university intranet. In some implementations, devices may communicate via the network 124 without traversing an external network, such as the Internet. In some implementations, devices connected via the network 124 may be walled off from accessing the Internet. As an example, the network 124 may not be connected to the Internet. Accordingly, e.g., the user device 102 may communicate with the subdivision boundary system 104 directly (via wired or wireless communications) or via the network 124, without using the Internet. Thus, even if the network 124 or the Internet is down, the subdivision boundary system 104 may continue to communicate and function via direct communications (and/or via the network 124).

User device 102 may be used to access various components of the network environment 100 and the subdivision boundary system 104 over the network 124. User device 102 illustratively correspond to any computing device that provides a means for a user or admin to interact with components of the subdivision boundary system 104. For example, a user, with user device 102, may access the subdivision boundary system 104 via the frontend 110 to generate subdivision boundaries. In some examples, the frontend 110 may be implemented on the user device 102. Of course, other activities may also be performed by a user with a user device 102. User device 102 may include user interfaces or dashboards that connect a user with a machine, system, or device. In various implementations, user device 102 include computer devices with a display and a mechanism for user input (e.g., mouse, keyboard, voice recognition, touch screen, and/or the like). In various implementations, the user device 102 include desktops, tablets, e-readers, servers, wearable device, laptops, smartphones, computers, gaming consoles, and the like. In some implementations, user device 102 can access a cloud provider network via the network 124 to view or manage their data and computing resources, as well as to use websites and/or applications hosted by the cloud provider network. Elements of the cloud provider network may also act as clients to other elements of that network. Thus, user device 102 can generally refer to any device accessing a network-accessible service as a client of that service.

Subdivision boundary system 104 may be configured to generate a subdivision boundary associated with parcels of land associated with a subdivision name. Subdivision boundary system 104 can comprise various systems or modules configured to execute processes directed to generating a subdivision boundary based on existing and extracted subdivision names from parcel legal descriptions. Subdivision boundary system 104 can include the components as shown in FIG. 1, but can also include more or less components in additional embodiments. Each component of the subdivision boundary system 104 will be discussed in turn.

Parcel system 106 may be configured to access data from various data stores to process parcel data for generation of subdivision boundaries. Parcel system 106 can access data stores, such as the parcel data store 112. In addition, the parcel system 106 can access various models, such as the classifier model data store 118, the extraction model data store 120, and the standardization model data store 122. Parcel system 106 can access various models to identify and extract subdivision names from parcel data. In addition, the parcel system 106 can access models to standardize subdivision names. Processes executed by the parcel system 106 can result in standardized subdivision names and information for the boundary system 108 to generate boundaries corresponding to subdivisions.

Parcel data store 112 may be configured to store data relating to parcels of land. Parcel data can include any information relating to geographic spatial data. Parcel data can include information from public records, such as census data resources (e.g., regional, national). In some embodiments, parcel data can relate to a parcel of land located in any geographical location. For example, parcel data associated with a parcel of land can include any information, such as a parcel ID, a parcel geometry, a street name, a street number, a zip code, a county identifier, a census block group identifier, a legal description, a land use code, a property indicator, a land area, a year of construction, an assessor parcel number, and the like. In some embodiments, parcel data associated with the parcel of land can include an associated subdivision name. In some embodiments, additional types of information not listed above is included in the parcel data associated with the parcel of land. In some embodiments, parcel data associated with the parcel of land is missing information and/or does not contain all information as listed above. For example, parcel data may be missing the subdivision name. In some embodiments, parcel data store 112 includes a list of parcels with associated parcel data. In some embodiments, parcel data store 112 is stored in a remote location and accessed by the subdivision boundary system 104 by the network 124.

Classifier model data store 118 can be configured to store models, algorithms, or other processes to be accessed by the subdivision boundary system 104 or components of the subdivision boundary system 104, such as the parcel system 106. Models stored in the classifier model data store 118 can include any engine, service, application, program, process, etc. configured to determine whether the parcel data contains a subdivision name (the “classifier model”). In addition, the classifier model can be configured to predict, in the case when the parcel data is missing a subdivision name, whether the subdivision name can be extracted or predicted from the parcel data. In some embodiments, the classifier model outputs parcel data that has been labeled as containing a subdivision name, not containing a subdivision name, containing a legal description with a subdivision name, etc. In some embodiments, the classifier model includes any artificial intelligence (AI) model such as machine learning (ML) models, deep learning (DL) models, large language models (LLMs), and the like. Classifier model can include a natural language processing (NLP) model configured to classify text-based parcel data.

Extraction model data store 120 can be configured to store additional models, algorithms, or other processes to be accessed by the subdivision boundary system 104 or components of the subdivision boundary system 104, such as the parcel system 106. Models stored in the extraction model data store 120 can include any engine, service, application, program, process, etc. configured to extract components from the parcel data, such as subdivision data (the “extraction model”). In some embodiments, the extraction model extracts the subdivision name from the parcel data. In the case when the parcel data is missing the subdivision name, the extraction model can infer or predict the subdivision name based on the parcel data, such as information in the legal description. In some embodiments, the extraction model includes any AI model such as an ML model, DL model, LLM, and the like. Extraction model can include an NLP model configured to extract portions of the text-based parcel data.

Standardization model data store 122 can be configured to store additional models, algorithms, or other processes to be accessed by the subdivision boundary system 104 or components of the subdivision boundary system 104, such as the parcel system 106. Models stored in the standardization model data store 122 can include any engine, service, application, program, process, etc. configured to standardize the extracted subdivision name (the “standardization model”). To standardize a subdivision name, the standardization model can interpolate missing subdivision names from legal descriptions within the parcel data. In addition, the standardization model can select a subdivision name for a group of parcels based on the extracted subdivision information. In some embodiments, the standardization model includes any AI model such as an ML model, DL model, LLM, and the like. Extraction model can include an NLP model configured to standardize the text-based subdivision names.

Models stored in the classifier model data store 118, the extraction model data store 120, and the standardization model data store 122. Models can be trained on training data. For example, the models can be trained with training data that includes parcel data relating to a parcel of land (or property). Training data can be labeled. For example, a set of text labels derived from the legal descriptions of the parcel data can be included with the set of training data. By training the models with the training data, the models can be trained to classify and extract a subdivision name from the parcel data.

The classification model and the extraction model can be trained with training data that has labels corresponding to components of the parcel data. For example, the training data can include parcel data in which the legal description has been labeled according to the various components (e.g., subdivision name, phase, section, etc.). In response to the input parcel data, the classification model can be trained to determine whether the parcel data contains subdivision information (e.g., subdivision name) and whether a subdivision name is included within the legal description. In response to the input parcel data, the extraction model can be trained to extract components from the parcel data, such as the subdivision name.

The standardization model can be trained with training data relating to sets of subdivision names (or subdivision information). For example, a set of subdivision names can include a subdivision name, variations of the subdivision name, or alternative subdivision names. By inputting the training data into the standardization model, the standardization model can determine the most accurate subdivision name out of the set of subdivision names.

Subdivision data store 114 can be configured to store data relating to extracted and standardized subdivisions. For example, the subdivision data store 114 can store subdivision information relating to the parcels of land.

Boundary system 108 can be configured to generate a subdivision boundary (or a parcel geometry) associated with a subdivision. Boundary system 108 can access the subdivision information (e.g., subdivision names) stored in the subdivision data store 114 and other information (e.g., map information, geographical information) to generate a boundary corresponding to a subdivision. Boundary system 108 can edit, update, or otherwise adjust the geometries of existing boundaries or create new boundaries based on the subdivision information as extracted or processed by the parcel system 106. In some embodiments, the boundary system 108 determines a boundary based on the attributes of a subdivision, such as the start year of its development, the latest year of its development, all the parcels that constitute the subdivision, the number of parcels, its total area, and its land type, such as residential, commercial, or industrial. In some embodiments, subdivision attributes can be derived by aggregating the attributes of individual parcels.

Boundary data store 116 can be configured to store information associated with boundaries generated by the boundary system 108. For examples, boundaries generated by the boundary system 108 corresponding to a subdivision. In some embodiments, the boundaries generated by the boundary system 108 and stored in the boundary data store 116 are associated or integrated with map data (e.g., geospatial locations). Data stored in the boundary data store 116 can be presented to a user via an interface, such as a map interface or other user interface. The map data can be used for various purposes or by various devices, including mobile devices for navigation or land assessments (e.g., for identifying parcel boundaries, for identifying changes in parcels over time, for value assessments, etc.), workstations for land assessments, autonomous vehicles for navigation, unmanned aerial vehicles like drones for conducting terrestrial assessments, delivery vehicles for delivering shipments, and/or the like.

To facilitate interaction between the subdivision boundary system 104 and the user device 102 via the network 124, the subdivision boundary system 104 can include the frontend 110. Frontend 110 can include any presentation layer (e.g., experience layer, user interface) such as a user-facing interface or platform through which a user of the user device 102 may access and interact with the subdivision boundary system 104. In some embodiments, frontend 110 can include an interface in which subdivision boundaries can be displayed.

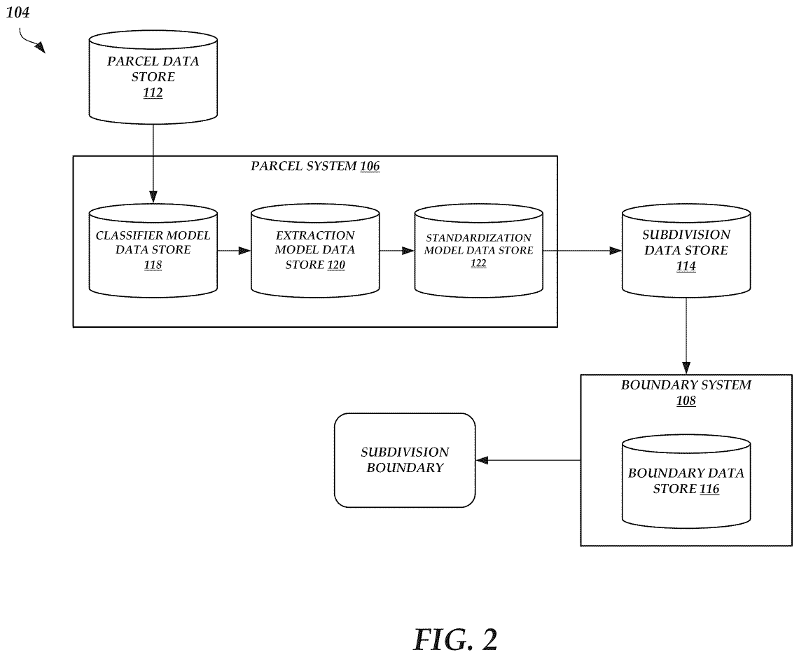

FIG. 2 is an example data flow process in which the subdivision boundary system 104 may operate to generate a subdivision boundary, according to various aspects of the present disclosure. The subdivision boundary system 104 may be configured to generate subdivision boundaries corresponding to subdivisions based on extracted subdivision information from parcel data.

In a first part, the subdivision boundary system 104 can access parcel data from the parcel data store 112. Parcel data in the parcel data store 112 can include any information relating to geographic spatial data. Parcel data can include information from public records, such as census data resources (e.g., regional, national, etc.). In some embodiments, parcel data can relate to a parcel of land located in any geographical location. For example, parcel data associated with a parcel of land can include any information, such as a parcel ID, a parcel geometry, a street name, a street number, a zip code, a county identifier, a census block group identifier, a legal description, a land use code, a property indicator, a land area, a year of construction, an assessor parcel number, and the like. In some embodiments, parcel data associated with the parcel of land can include an associated subdivision name. In some embodiments, additional types of information not listed above is included in the parcel data associated with the parcel of land. In some embodiments, parcel data associated with the parcel of land is missing information and/or does not contain all information as listed above. For example, parcel data may be missing the subdivision name.

In some embodiments, parcel data store 112 includes a list of parcels with associated parcel data. For example, the list of parcels can include all associated parcel data information, such as listed above. In addition, not all parcels can contain all types of parcel information (e.g., some information may be missing or inaccurate).

As noted herein, a subdivision name can refer to an identifier associated a subdivision. A subdivision can include any number of parcels, each of which can be associated with the subdivision name.

A legal description can include a written statement that defines the boundaries of a piece of real property (e.g., parcel). The legal description can identify the precise location and measurements of the parcel. For example, the legal description can include a metes and bounds description, which can include a description that identifies the boundaries of a parcel by natural and/or artificial landmarks. The legal description can also include a public land (or “rectangular”) survey system description, which identifies the parcel using a grid of imaginary lines to demarcate the parcel. In addition, the legal description can include plat or block method descriptions, which include a permanent reference monument or control point used to identify the parcel. Alternatively, or in addition, the legal description can include one or more geographic coordinates that define a boundary of a parcel. In some embodiments, the legal description associated with a parcel can include or indicate the associated subdivision name.

Upon accessing parcel data, subdivision information can be identified and/or extracted. To extract information, the parcel system 106 can input the parcel data into models, such as natural language processing models. As shown in FIG. 2, the parcel system 106 can access at least three models stored in data stores (e.g., classifier model data store 118, extraction model data store 120, standardization model data store 122). Although shown in FIG. 1 and FIG. 2 as separate data stores, it will be understood that the model data stores may be combined.

In some embodiments, the parcel system 106 inputs parcel data into the classifier model. As noted herein, the classifier model can be configured to determine whether the parcel data contains subdivision data, such as a subdivision name. As noted above, parcel data relating to a parcel of land may not always contain all information, and as such, may be missing a subdivision name. The classifier model can determine, based on the input parcel data, whether the parcel data contains a subdivision name. In some embodiments, in the case when the classifier model determines that that parcel data is missing a subdivision name, the classifier model can predict whether the subdivision name can be extracted, parsed, or inferred from other components of the parcel data, such as the legal description. For example, the legal description may contain the subdivision name, a portion of the subdivision name, or other information indicating the associated subdivision in which the parcel of land is included in. In some embodiments, the parcel system 106 marks, labels, or otherwise indicates which parcels contain a valid legal description but no subdivision name. In some embodiments, the parcel system 106 indicates which parcels without a subdivision name contain a valid legal description that is not likely to contain or indicate the subdivision name. In some embodiments, these parcels are ignored, discarded, or not further processed by the subdivision boundary system 104. Parcel system 106, by marking, labeling, or otherwise organizing parcels (and parcel data) that contain or are likely to contain a subdivision name, can determine filtered parcel data (e.g., a list of candidate parcels) for further extraction and standardization.

Upon identifying the filtered parcel data in which subdivision names can be extracted, the parcel system 106 can input the parcel data into the extraction model. Extraction model can be configured to extract subdivision information from the parcel data. For example, the extraction model can extract subdivision information from the legal description of the parcel data. Subdivision information can include any information relating to the subdivision, such as a subdivision name, phase, section, and the like. As noted herein, developers often undertake large projects in multiple phases to manage construction, financing, and marketing. A subdivision phase (or “phase”) can indicate a stage or step in an ongoing process of subdividing a plot of land. A subdivision section (or “section”) can indicate a portion or section in which the parcel of land belongs to within the subdivision. Based on the text of the legal description, the extraction model can identify portions corresponding to the subdivision name, phase, section, and the like. In some embodiments, the extraction model can identify and extract the subdivision name for a parcel that is missing the subdivision name.

In some examples, there may be multiple parcels located within the same subdivision. However, there may be discrepancies within the subdivision names of different parcels despite the parcels belonging to the same subdivision. Upon extracting the subdivision name (and other subdivision data) from the parcel data, the subdivision names belonging to parcels within the same subdivision can be standardized. In some embodiments, before the subdivision data is input into the standardization model, subdivision names extracted from the parcel data can be combined with existing subdivision names to generate a list of subdivision names to be standardized. The standardization model can be configured to receive the list of subdivision names associated with parcels.

In a first part, the standardization model may group parcels and fill in missing subdivision names. This process can be executed for parcels in which the subdivision name could not be inferred or extracted from the legal description. To fill in missing subdivision names, the standardization model can interpolate and/or infer the missing subdivision name based on additional parcel data. For example, the standardization model can infer the subdivision name for a parcel based on comparing the parcel to neighboring parcels on adjacent addresses or streets to identify neighboring parcels with the same land use and same zip code as the parcel and identifying the subdivision name of these neighboring parcels.

In a second part, the standardization model can group parcels to select the most accurate subdivision name. In some embodiments, the standardization model groups parcels based on census data (e.g., Census Block Groups) or other logical or relevant groupings. Parcels within a group may have the same or similar subdivision names. To standardize the subdivision name, the standardization model may identify the name associated with the most parcels within the group as the “most accurate” name. In some embodiments, the standardization model may identify the most accurate name according to additional or alternative processes.

In one example, standardization model can access parcel data relating to parcels with subdivision name “TRAVIS HEIGHTS” (57 parcels with this subdivision name) and “TRAVIS HEIGHTS SEC 2” (11 parcels with this subdivision name). Based on this information, the standardization model may determine that the more accurate subdivision name is “TRAVIS HEIGHTS” (because the section number is omitted) and update the other parcels to this subdivision name.

Upon selection of a subdivision name, the parcel system 106 can update existing databases and/or store the standardized information in a new datastore. Subdivision data store 114 can be configured to store information that has been standardized by the parcel system 106. In some embodiments, the standardized parcel data (including the standardized subdivision name) can be organized in the subdivision data store 114 by subdivision. In some embodiments, the subdivision data store 114 and the parcel data store 112 are the same data store.

In response to standardizing the subdivision data (e.g., subdivision names) for parcels of the parcel data, the subdivision boundary system 104 can determine subdivisions. In some embodiments, the subdivision boundary system 104 (via the parcel system 106 and/or the boundary system 108) can determine a subdivision based on the parcels with the same subdivision name. A subdivision may be formed whenever at least a certain number of parcels (e.g., three) share the same standardized name. In addition, a subdivision can be formed whenever at least a certain number of parcels share the same standardized name within a geographic entity or other area. For example, the subdivision boundary system 104 can form a subdivision when at least a certain number of parcels share the same standardized name within a census tract (or census area, census district, meshblock, etc.). A census tract can refer to a relatively permanent geographic entity within a county (or any statistical equivalent of a county) that is delineated by a committee of local data users. In some examples, each subdivision is based on parcels sharing the same standardized subdivision name within a given census tract. There may be multiple subdivisions with the same standardized subdivision name within the same county (or other geographic entity) if the subdivisions are located within different census tracts.

Boundary system 108 can form a boundary associated with the subdivision. To determine a boundary for the subdivisions, the boundary system 108 can access the subdivision data store 114. As noted above, standardized subdivision information can be stored in the subdivision data store 114. Parcel data can include geographical information, such as an area (e.g., polygon or shape) associated with the parcel size and geospatial location. Boundary system 108 can draw a boundary line around all the parcels within a subdivision to indicate the outer boundaries of the subdivision. In some embodiments, all parcel geometries assigned to a given subdivision are merged into a single subdivision geometry. Optionally, the boundary system 108 can merge parcel geometries assigned to a given subdivision into a single subdivision geometry as long as the number of parcels corresponding to the parcel geometries to be merged is greater than a threshold number of parcels. It is noted that there may be multiple subdivisions with the same name, within the same county (or other geographical area). However, depending on the location of the subdivision within different census tracts, the boundary system 108 may create separate boundaries for the different subdivisions.

In addition to generating boundaries associated with subdivisions, the boundary system 108 can generate a buffer associated with the subdivisions. A buffer can be extended around each subdivision boundary to include internal street right of ways and other components. Adding a buffer to the subdivision boundary can reduce overlaps between subdivisions. The land within a buffer may not be considered part of a subdivision.

Upon generation of subdivision boundaries, the boundary system 108 can store the subdivision boundaries in the boundary data store 116. Boundary data store 116 can store spatial data, geometric data, mapping data, polygonal data, and any other information relating to the generated boundaries.

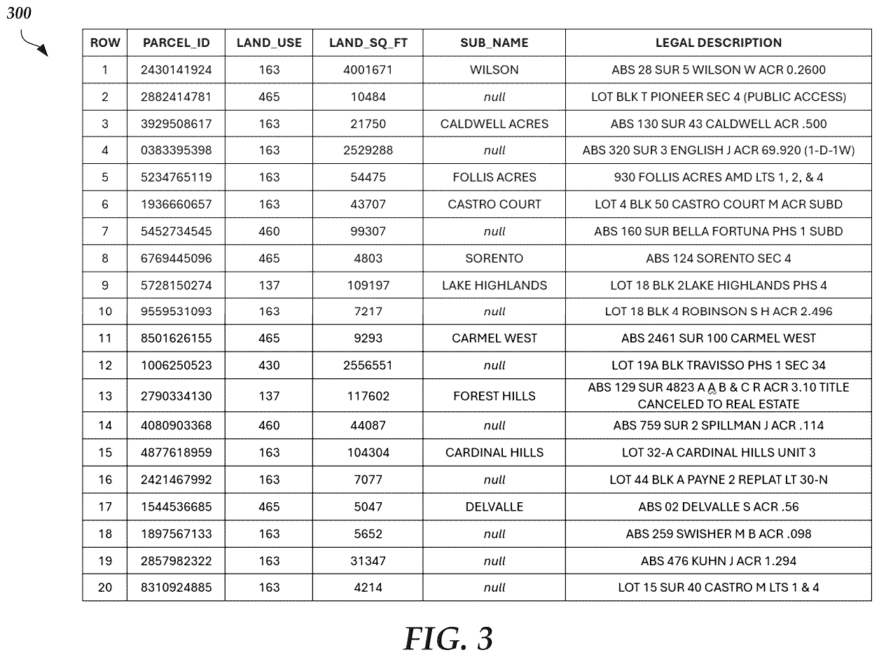

FIG. 3 illustrates example parcel data 300 that is classified by the subdivision boundary system 104, according to various aspects of the present disclosure.

Parcel data 300 can be stored in the parcel data store 112. As shown in FIG. 3, the parcel data 300 can include a list, table, matrix, etc. of information relating to a number of parcels. In some embodiments, parcel data 300 can relate to a parcel of land located in any geographical location. For example, parcel data 300 associated with a parcel of land can include any information, such as a parcel ID, a parcel geometry, a street name, a street number, a zip code, a county identifier, a census block group identifier, a legal description, a land use code, a property indicator, a land area, a year of construction, an assessor parcel number, and the like. In some embodiments, parcel data associated with the parcel of land can include an associated subdivision name. However, in some embodiments, information may be missing from the parcel data 300. For example, the subdivision names appear to be missing for the parcel data 300.

As shown in FIG. 3, parcel data 300 includes 20 parcels. The parcels do not need to be in the same geographical area. There may be duplicate parcels, adjacent parcels, or even parcels that are not located proximate to each other. Parcel data 300 also includes columns indicating characteristics relating to the parcels. For example, each parcel can be associated with a unique parcel ID. A parcel ID (or parcel number) can include a number or identifier that is assigned to a parcel by the local government or governing organization (e.g., an organization that is in charge of the real estate taxes in that parcel's area). Parcel data 300 can also include a land square footage, as shown in FIG. 3, and a legal description.

In some embodiments, parcel data 300 can be updated, supplemented, or otherwise edited. For example, parcel data 300 can be periodically updated with new census information, surveys, and other information relating to parcels. Parcel data 300 can be accessed by the subdivision boundary system 104 to generate subdivisions and subdivision boundaries for each parcel.

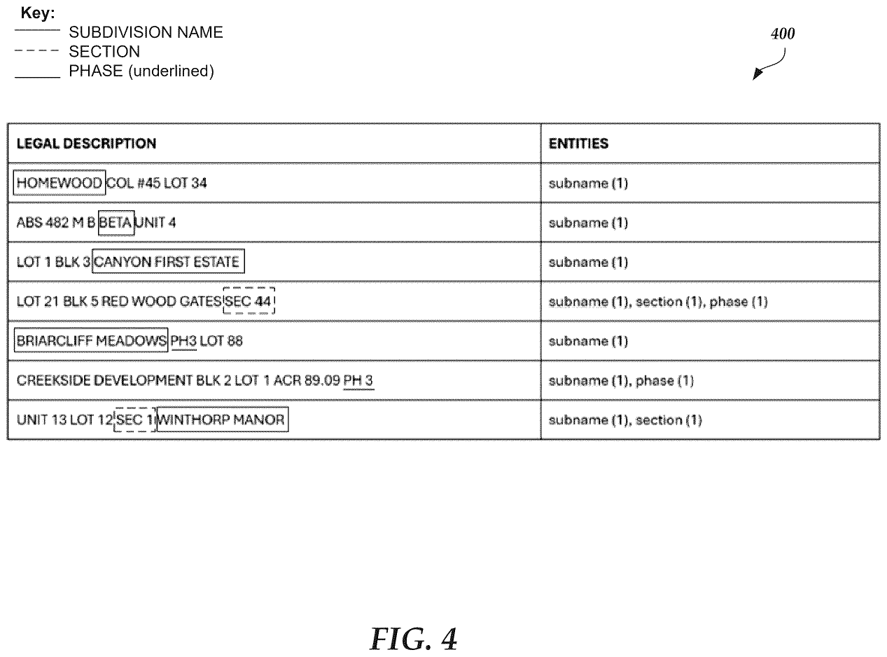

FIG. 4 illustrates example classified parcel data that is extracted by the subdivision boundary system 104, according to various aspects of the present disclosure. As shown in FIG. 4, legal descriptions 400 can be analyzed by the extraction model for subdivision data. Legal descriptions 400 can correspond to the parcel data 300 (not shown in FIG. 4). As discussed above, legal descriptions can include written statements that define boundaries of a piece of real property (e.g., parcel). The legal descriptions can identify the precise location and measurements of parcels.

In some embodiments, the extraction model can identify and extract different components from the legal description. For example, as shown by the highlighted portions of the legal descriptions 400, the extraction model can extract the subdivision name, the phrase, or section of the parcel.

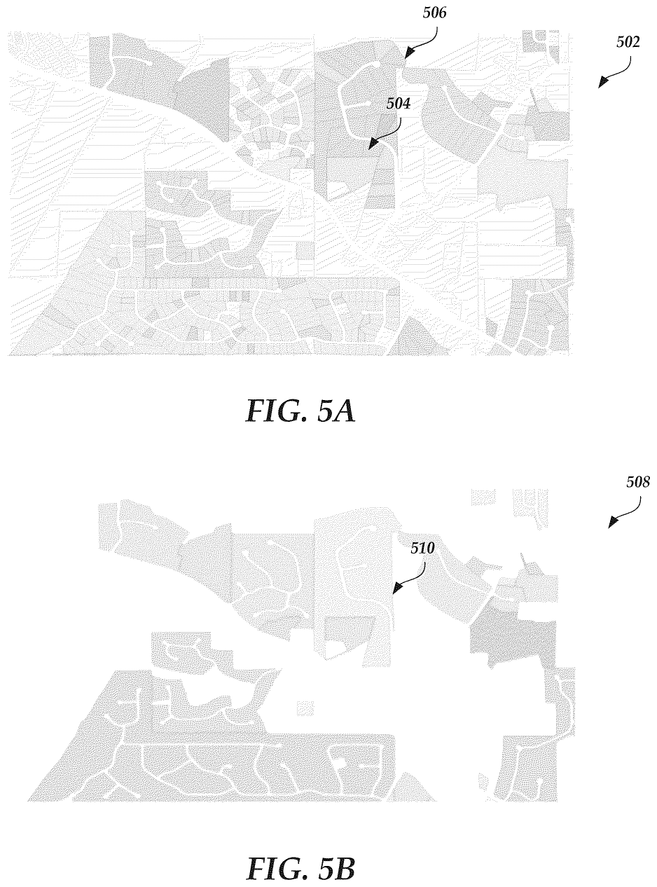

FIGS. 5A and 5B illustrate example map interfaces that demonstrate subdivision boundaries generation process as performed by the subdivision boundary system 104, according to various aspects of the present disclosure.

As shown in FIG. 5A, parcel map interface 502 illustrates various parcels of land in a geographical area. Each parcel can be illustrated by a geometric polygon or miscellaneous shape. Roads and other geographical features can also be shown in the parcel map interface 502. Parcel 504 is shown as a polygon within the parcel map interface 502. Parcel 504 can be associated with parcel data stored in the parcel data store 112. For example, parcel 504 can be associated with a subdivision name, legal description, and/or another other information. In some embodiments, parcel 504 is located within subdivision 506.

As described above, the subdivision boundary system 104 can extract subdivision information from parcel data relating to parcel 504 (and other parcels within the parcel map interface 502) for the generation of subdivision boundaries. In some embodiments, the subdivision boundary system 104 can determine that all the parcels within subdivision 506 form a valid subdivision according to the processes described herein. In addition, the subdivision boundary system 104 can group together parcels within the valid subdivision that contain the same standardized subdivision name.

The output of the subdivision boundary system 104 can include subdivision map interface 508, as shown in FIG. 5B. As shown, the individual parcels within the subdivisions can be merged together to form a cohesive subdivision. In addition, boundaries of the subdivisions can be shown, such as boundary 510 corresponding to the subdivision 506.

As described herein, the subdivision boundary system 104 can implement a buffer around the subdivision to account for internal roads and/or right of ways. As shown by the cutouts of the streets, the subdivisions can exclude roads or other internal, non-parcel areas.

In some embodiments, parcel map interface 502 and subdivision 506 can be stored within the boundary data store 116. In addition, the parcel map interface 502 and the subdivision 506 can be displayed on the frontend 110, such as via the user device 102.

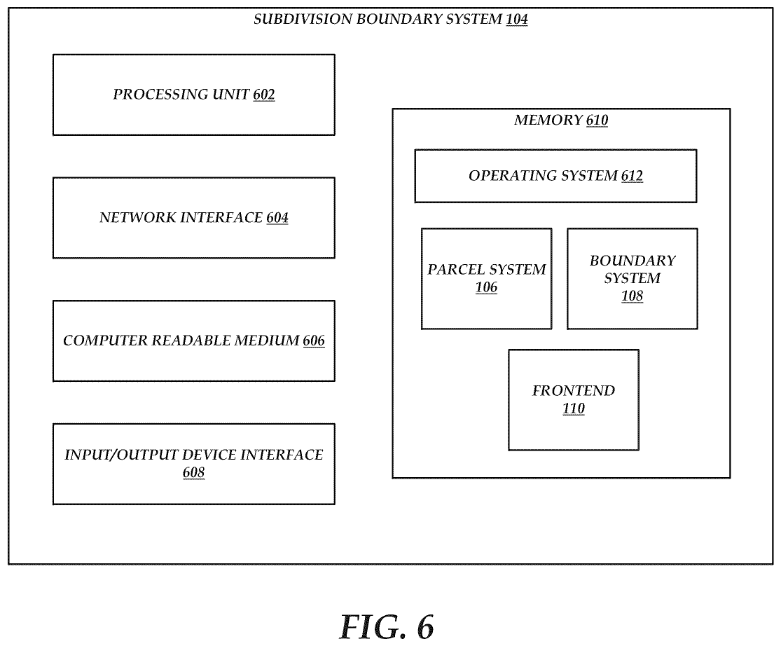

FIG. 6 is a block diagram illustrating components of an example computing system that can be used to implement the various systems and methods described herein.

The general architecture of the system depicted in FIG. 6 includes an arrangement of computer hardware and software that may be used to implement aspects of the present disclosure. The hardware may be implemented on physical electronic devices, as discussed in greater detail below. The system may include many more (or fewer) elements than those shown in FIG. 6. It is not necessary, however, that all of these generally conventional elements be shown in order to provide an enabling disclosure. Additionally, the general architecture illustrated in FIG. 6 may be used to implement one or more of the other components illustrated in the figures. As illustrated, the system includes a processing unit 602, a network interface 604, a computer-readable medium drive 606, and an input/output device interface 608, and memory 610, all of which may communicate with one another by way of a communication bus.

The network interface 604 may provide connectivity to one or more networks or computing systems. The processing unit 602 may thus receive information and instructions from other computing systems or services via the network. The processing unit 602 may also communicate to and from memory 610 and further provide output information for an optional display (not shown) via the input/output device interface 608. The input/output device interface 608 may also accept input from an optional input device (not shown).

The memory 610 may contain computer program instructions (grouped as units in some embodiments) that the processing unit 602 executes in order to implement one or more aspects of the present disclosure, along with data used to facilitate or support such execution. While shown in FIG. 6 as a single set of memory 610, memory 610 may in practice be divided into tiers, such as primary memory and secondary memory, which tiers may include (but are not limited to) random access memory (RAM), 3D XPOINT memory, flash memory, magnetic storage, and the like. For example, primary memory may be assumed for the purposes of description to represent a main working memory of the system, with a higher speed but lower total capacity than a secondary memory, tertiary memory, etc.

The memory 610 may store an operating system 612 that provides computer program instructions for use by the processing unit 602 in the general administration and operation of the subdivision boundary system 104. The memory 610 may further include computer program instructions and other information for implementing aspects of the present disclosure. For example, in one embodiment, the memory 610 includes the parcel system 106, the boundary system 108, and the frontend 110. Each of these components may represent code executable to perform the processes described herein.

The system of FIG. 6 is one illustrative configuration of such a device, of which others are possible. For example, while shown as a single device, a system may in some embodiments be implemented as a logical device hosted by multiple physical host devices. In other embodiments, the system may be implemented as one or more virtual devices executing on a physical computing device. While described in FIG. 6 as a subdivision boundary system 104, similar components may be utilized in some embodiments to implement other devices shown herein.

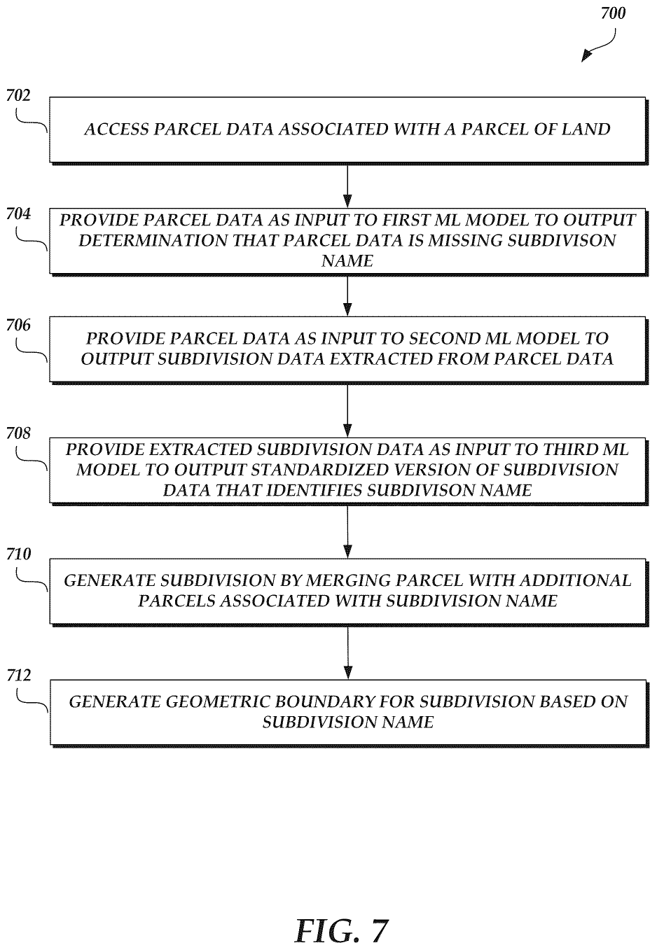

FIG. 7 is a flow diagram illustrating an example routine 700 for generating a subdivision boundary, according to various aspects of the present disclosure. Routine 700 may be executed by the subdivision boundary system 104 and various components of the subdivision boundary system 104. Specifically, the routine 700 may be executed by a processor, such as the processing unit 602, shown in FIG. 6.

At block 702, parcel data associated with a parcel of land is accessed. As noted herein, the parcel data comprises information relating to a parcel of land. In some embodiments, parcel data store 112 is stored in a remote location and accessed by the subdivision boundary system 104 by the network 124.

Parcel data in the parcel data store 112 can include any information relating to geographic spatial data. Parcel data can include information from public records, such as Census data resources (e.g., regional, national). In some embodiments, parcel data can relate to a parcel of land located in any geographical location. For example, parcel data associated with a parcel of land can include any information, such as a parcel ID, a parcel geometry, a street name, a street number, a zip code, a county identifier, a census block group identifier, a legal description, a land use code, a property indicator, a land area, a year of construction, assessor parcel number, and the like. In some embodiments, parcel data associated with the parcel of land can include an associated subdivision name. In some embodiments, additional types of information not listed above is included in the parcel data associated with the parcel of land. In some embodiments, parcel data associated with the parcel of land is missing information and/or does not contain all information as listed above. For example, parcel data may be missing the subdivision name.

At block 704, parcel data is provided into a first machine learning (ML) model to determine whether a subdivision name is missing. The first ML model can include a classifier model, such as the one described above. In some embodiments, the first ML model (the classifier model) can determine whether the parcel data is missing a subdivision name.

In some embodiments, at block 704, the parcel system 106 inputs parcel data into the classifier model. As noted herein, the classifier model can be configured to determine whether the parcel data contains subdivision data, such as a subdivision name. As noted above, parcel data relating to a parcel of land may not always contain all information, and as such, may be missing a subdivision name. The classifier model can determine, based on the input parcel data, whether the parcel data contains a subdivision name. In some embodiments, in the case when the classifier model determines that that parcel data is missing a subdivision name, the classifier model can predict whether the subdivision name can be extracted, parsed, or inferred from other components of the parcel data, such as the legal description. For example, the legal description may contain the subdivision name, a portion of the subdivision name, or other information indicating the associated subdivision in which the parcel of land is included in. In some embodiments, the parcel system 106 marks, labels, or otherwise indicates which parcels contain a valid legal description but no subdivision name. In some embodiments, the parcel system 106 indicates which parcels without a subdivision name contain a valid legal description that is not likely to contain or indicate the subdivision name. In some embodiments, these parcels are ignored, discarded, or not further processed by the subdivision boundary system 104. Parcel system 106, by marking, labeling, or otherwise organizing parcels (and parcel data) that contain or are likely to contain a subdivision name, can determine filtered parcel data (e.g., a list of candidate parcels) for further extraction and standardization.

At block 706, parcel data is provided to a second ML model to extract subdivision data. The second ML model can include an extraction model, such as the one described above. In some embodiments, the second ML model (the extraction model) can extract subdivision data from the parcel data.

In some embodiments, at block 706, the extraction model can be configured to extract subdivision information from the parcel data, such as from the legal description. Subdivision information can include any information relating to the subdivision in which the parcel belongs, such as a subdivision name, phase, section, etc. Based on the text of the legal description, the extraction model can identify portions corresponding to the subdivision name, phase, section, and the like. In some embodiments, the extraction model can identify and extract the subdivision name for a parcel that is missing the subdivision name.

At block 708, subdivision data is standardized into a subdivision name. Specifically, at block 708, the subdivision data is provided into a third ML model to standardize the subdivision data into a subdivision name. As noted herein, there may be multiple parcels located within the same subdivision. However, there may be discrepancies within the subdivision names of different parcels despite the parcels belonging to the same subdivision. Upon extracting the subdivision name (and other subdivision data) from the parcel data, the subdivision names belonging to parcels within the same subdivision can be standardized. In some embodiments, before the subdivision data is input into the standardization model, subdivision names extracted from the parcel data can be combined with existing subdivision names to generate a list of subdivision names to be standardized. The standardization model can be configured to receive the list of subdivision names associated with parcels.

Standardization model, at block 708, can group parcels and fill in missing subdivision names. This process can be executed for parcels in which the subdivision name could not be inferred or extracted from the legal description. To fill in missing subdivision names, the standardization model can interpolate and/or infer the missing subdivision name based on additional parcel data. For example, the standardization model can infer the subdivision name for a parcel based on comparing the parcel to neighboring parcels on adjacent addresses or streets to identify neighboring parcels with the same land use and same zip code as the parcel and identifying the subdivision name of these neighboring parcels.

In addition, in some embodiments, the standardization model can group parcels to select the most accurate subdivision name. In some embodiments, the standardization model groups parcels based on census data (e.g., Census Block Groups) or other logical or relevant groupings. Parcels within a group may have the same or similar subdivision names. To standardize the subdivision name, the standardization model may identify the name associated with the most parcels within the group as the “most accurate” name. In some embodiments, the standardization model may identify the most accurate name according to additional or alternative processes.

Upon selection of a subdivision name, the parcel system 106 can update existing databases and/or store the standardized information in a new datastore. Subdivision data store 114 can be configured to store information that has been standardized by the parcel system 106. In some embodiments, the standardized parcel data (including the standardized subdivision name) can be organized in the subdivision data store 114 by subdivision. In some embodiments, the subdivision data store 114 and the parcel data store 112 are the same data store.

At block 710, a subdivision is generated by merging the additional parcels associated with the subdivision name (optionally as long as the number of parcels to be merged is greater than a threshold number of parcels). In response to standardizing the subdivision data (e.g., subdivision names) for parcels of the parcel data, the subdivision boundary system 104 can determine subdivisions. In some embodiments, the subdivision boundary system 104 (via the parcel system 106 and/or the boundary system 108) can determine a subdivision based on the parcels with the same subdivision name. A subdivision may be formed whenever at least a certain number of parcels (e.g., three) share the same standardized name. In addition, a subdivision can be formed whenever at least a certain number of parcels share the same standardized name within a geographic entity or other area. For example, the subdivision boundary system 104 can form a subdivision when at least a certain number of parcels share the same standardized name within a census tract (or census area, census district, meshblock, etc.). A census tract can refer to a relatively permanent geographic entity within a county (or any statistical equivalent of a county) that is delineated by a committee of local data users. In some examples, each subdivision is based on parcels sharing the same standardized subdivision name within a given census tract. There may be multiple subdivisions with the same standardized subdivision name within the same county (or other geographic entity) if the subdivisions are located within different census tracts.

At block 712, a geometric boundary for the subdivision is generated. In some embodiments, the geometric boundary for the subdivision is generated based on the subdivision name.

In some embodiments, the boundary system 108 can form a boundary associated with the subdivision. To determine a boundary for the subdivisions, the boundary system 108 can access the subdivision data store 114. As noted above, standardized subdivision information can be stored in the subdivision data store 114. Parcel data can include geographical information, such as an area (e.g., polygon or shape) associated with the parcel size and geospatial location. Boundary system 108 can draw a boundary line around all the parcels within a subdivision to indicate the outer boundaries of the subdivision. In some embodiments, all parcel geometries assigned to a given subdivision are merged into a single subdivision geometry. Optionally, the boundary system 108 merges parcel geometries assigned to a given subdivision into a single subdivision geometry as long as the number of parcels corresponding to the parcel geometries to be merged is greater than a threshold number of parcels. It is noted that there may be multiple subdivisions with the same name, within the same county (or other geographical area). However, depending on the location of the subdivision within different census tracts, the boundary system 108 may create separate boundaries for the different subdivisions.

In addition to generating boundaries associated with subdivisions, the boundary system 108 can, at block 712, generate a buffer associated with the subdivisions. A buffer can be extended around each subdivision boundary to include internal street right of ways and other components. Adding a buffer to the subdivision boundary can reduce overlaps between subdivisions.

Upon generation of subdivision boundaries, the boundary system 108 can, at block 712, store the subdivision boundaries in the boundary data store 116. Boundary data store 116 can store spatial data, geometric data, mapping data, polygonal data, and any other information relating to the generated boundaries.

All of the methods and tasks described herein may be performed and fully automated by a computer system. The computer system may, in some cases, include multiple distinct computers or computing devices (e.g., physical servers, workstations, storage arrays, cloud computing resources, etc.) that communicate and interoperate over a network to perform the described functions. Each such computing device typically includes a processor (or multiple processors) that executes program instructions or modules stored in a memory or other non-transitory computer-readable storage medium or device (e.g., solid state storage devices, disk drives, etc.). The various functions disclosed herein may be embodied in such program instructions or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid-state memory chips or magnetic disks, into a different state. In some embodiments, the computer system is a cloud-based computing system whose processing resources are shared by multiple distinct business entities or other users.

Some or all of the statistical analysis methods described herein may be performed and fully automated by a computer system. The computer system may, in some cases, include multiple distinct computers or computing devices (e.g., physical servers, workstations, storage arrays, cloud computing resources, etc.) that communicate and interoperate over a network to perform the described functions. Each such computing device typically includes a processor (or multiple processors) that executes program instructions or modules stored in a memory or other non-transitory computer-readable storage medium or device (e.g., solid state storage devices, disk drives, etc.). The various functions disclosed herein may be embodied in such program instructions, or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid-state memory chips or magnetic disks, into a different state. In some embodiments, the computer system may be a cloud-based computing system whose processing resources are shared by multiple distinct business entities or other users.

The processes described herein or illustrated in the figures of the present disclosure may begin in response to an event, such as on a predetermined or dynamically determined schedule, on demand when initiated by a user or system administrator, or in response to some other event. When such processes are initiated, a set of executable program instructions stored on one or more non-transitory computer-readable media (e.g., hard drive, flash memory, removable media, etc.) may be loaded into memory (e.g., RAM) of a server or other computing device. The executable instructions may then be executed by a hardware-based computer processor of the computing device. In some embodiments, such processes or portions thereof may be implemented on multiple computing devices and/or multiple processors, serially or in parallel.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm elements described in connection with the embodiments disclosed herein can be implemented as electronic hardware (e.g., ASICs or FPGA devices), computer software that runs on computer hardware, or combinations of both. Moreover, the various illustrative logical blocks and modules described in connection with the embodiments disclosed herein can be implemented or performed by a machine, such as a processor device, a digital signal processor (“DSP”), an application specific integrated circuit (“ASIC”), a field programmable gate array (“FPGA”) or other programmable logic device, discrete gate or transistor logic, discrete hardware components, or any combination thereof designed to perform the functions described herein. A processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the rendering techniques described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements or steps. Thus, such conditional language is not generally intended to imply that features, elements or steps are in any way required for one or more embodiments or that one or more embodiments necessarily include logic for deciding, with or without other input or prompting, whether these features, elements or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, or Z). Thus, such disjunctive language is not generally intended to, and should not, imply that certain embodiments require at least one of X, at least one of Y, and at least one of Z to each be present.

Unless otherwise explicitly stated, articles such as “a” or “an” should generally be interpreted to include one or more described items throughout this application. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. Unless otherwise explicitly stated, the terms “set” and “collection” should generally be interpreted to include one or more described items throughout this application. Accordingly, phrases such as “a set of devices configured to” or “a collection of devices configured to” are intended to include one or more recited devices. Such one or more recited devices can also be collectively configured to carry out the stated recitations. For example, “a set of servers configured to carry out recitations A, B and C” can include a first server configured to carry out recitation A working in conjunction with a second server configured to carry out recitations B and C.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. All changes which come within the meaning and range of equivalency of the claims are to be embraced within their scope.

What is claimed is:

1. A system, comprising:
a computer-readable storage medium storing program instructions; and
one or more processors configured to execute the program instructions to cause the system to:
access parcel data, wherein the parcel data comprises information relating to a parcel of land;
provide parcel data as an input to a first machine learning model, wherein the first machine learning model outputs a determination that the parcel data is missing a subdivision name;
provide parcel data as an input to a second machine learning model, wherein the second machine learning model outputs subdivision data extracted from the parcel data;
provide the extracted subdivision data and the parcel data as an input to a third machine learning model, wherein the third machine learning model outputs a standardized subdivision data that identifies the subdivision name;
generate a subdivision by merging the parcel of land with additional parcels of land associated with the subdivision name; and
generate a geometric boundary for the subdivision based on the subdivision name and a subdivision attribute.

2. The system of claim 1, wherein the parcel data includes at least one of a parcel ID, a parcel geometry, a street name, a street number, a zip code, a county identifier, a census block group identifier, a legal description, a land use code, a property indicator, a land area, a year of construction, or assessor parcel number.

3. The system of claim 1, wherein the second machine learning model is configured to:
extract a first portion of subdivision data related to the subdivision name of the parcel;
extract a second portion of subdivision data related to a phase of the parcel; and
extract a third portion of the subdivision data related to a section of the parcel.

4. The system of claim 1, wherein the third machine learning model is configured to compare the subdivision name to subdivision names of neighboring parcels of land to identify the standardized subdivision data that identifies the subdivision name.

5. The system of claim 1, wherein the program instructions, when executed, further cause the one or more processors to generate the subdivision by merging the parcel of land with additional parcels of land associated with the subdivision name over a threshold number of parcels.

6. The system of claim 1, wherein the program instructions, when executed, further cause the one or more processors to generate a buffer associated with the geometric boundary, the buffer corresponding to at least one of a road, street, or right of way.

7. The system of claim 1, wherein the program instructions, when executed, further cause the one or more processors to cause display of the geometric boundary of the subdivision.

8. A method, comprising:
accessing parcel data, wherein the parcel data comprises information relating to a parcel of land;
providing parcel data as an input to a first machine learning model, wherein the first machine learning model outputs a determination that the parcel data is missing a subdivision name;
providing parcel data as an input to a second machine learning model, wherein the second machine learning model outputs subdivision data extracted from the parcel data;
providing the extracted subdivision data and the parcel data as an input to a third machine learning model, wherein the third machine learning model outputs a standardized subdivision data that identifies the subdivision name;
generating a subdivision by merging the parcel of land with additional parcels of land associated with the subdivision name; and
generating a geometric boundary for the subdivision based on the subdivision name and a subdivision attribute.

9. The method of claim 8, wherein the parcel data includes at least one of a parcel ID, a parcel geometry, a street name, a street number, a zip code, a county identifier, a census block group identifier, a legal description, a land use code, a property indicator, a land area, a year of construction, or assessor parcel number.

10. The method of claim 8, wherein the second machine learning model is configured to:
extract a first portion of subdivision data related to the subdivision name of the parcel;
extract a second portion of subdivision data related to a phase of the parcel; and
extract a third portion of the subdivision data related to a section of the parcel.

11. The method of claim 8, wherein the third machine learning model is configured to compare the subdivision name to subdivision names of neighboring parcels of land to identify the standardized subdivision data that identifies the subdivision name.

12. The method of claim 8, further comprising generating the subdivision by merging the parcel of land with additional parcels of land associated with the subdivision name over a threshold number of parcels.

13. The method of claim 8, further comprising generating a buffer associated with the geometric boundary, the buffer corresponding to at least one of a road, street, or right of way.

14. The method of claim 8, further comprising causing display of the geometric boundary of the subdivision.

15. One or more non-transitory computer-readable media storing computer-executable instructions that, when executed by a computing system comprising a processor, cause the computing system to:
access parcel data, wherein the parcel data comprises information relating to a parcel of land;
provide parcel data as an input to a first machine learning model, wherein the first machine learning model outputs a determination that the parcel data is missing a subdivision name;
provide parcel data as an input to a second machine learning model, wherein the second machine learning model outputs subdivision data extracted from the parcel data;
provide the extracted subdivision data and the parcel data as an input to a third machine learning model, wherein the third machine learning model outputs a standardized subdivision data that identifies the subdivision name;
generate a subdivision by merging the parcel of land with additional parcels of land associated with the subdivision name; and
generate a geometric boundary for the subdivision based on the subdivision name and a subdivision attribute.

16. The one or more non-transitory computer-readable media of claim 15, wherein the parcel data includes at least one of a parcel ID, a parcel geometry, a street name, a street number, a zip code, a county identifier, a census block group identifier, a legal description, a land use code, a property indicator, a land area, a year of construction, or assessor parcel number.

17. The one or more non-transitory computer-readable media of claim 15, wherein the second machine learning model is configured to:
extract a first portion of subdivision data related to the subdivision name of the parcel;
extract a second portion of subdivision data related to a phase of the parcel; and
extract a third portion of the subdivision data related to a section of the parcel.

18. The one or more non-transitory computer-readable media of claim 15, wherein the third machine learning model is configured to compare the subdivision name to subdivision names of neighboring parcels of land to identify the standardized subdivision data that identifies the subdivision name.

19. The one or more non-transitory computer-readable media of claim 15, wherein the computer-executable instructions, when executed, further cause the computing system to: generate the subdivision by merging the parcel of land with additional parcels of land associated with the subdivision name over a threshold number of parcels.

20. The one or more non-transitory computer-readable media of claim 15, wherein the computer-executable instructions, when executed, further cause the computing system to generate a buffer associated with the geometric boundary, the buffer corresponding to at least one of a road, street, or right of way.
